(19) United States
(12) Patent Application Publication
(10) Pub. No.: US 2006/0229397 A1
(43) Pub. Date: Oct. 12, 2006

(54) Moulded bodies used for illuminated advertsing and method for producing said bodies

(75) Inventors: Hans Lichtenstein, Reinheim (DE); Guenther Ittmann, Gross-Ulmstadt (DE)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Roehm GMBH & Co. KG, Darmstadt (DE)

(21) Appl. No.: 10/553,967

(22) PCT Filed: Mar. 2, 2004
(86) PCT No.: PCT/EP04/02062

§ 371 Date: Oct. 19, 2005

(30) Foreign Application Priority Data
May 23, 2003 (DE) 103 23 789.5

(51) Int. Cl. C08K 3/30

(52) U.S. Cl. 524/423; 524/556; 524/502

(57) ABSTRACT

The invention relates to moulded bodies for illuminated advertising, comprising a poly(meth)acrylate matrix, diffusion particles containing plastic and inorganic diffusion particles. Said moulded bodies contain between 0.05 and 0.5 wt. % diffusion particles containing plastic with a size ranging between 5 and 15 μm and between 0.1 and 3 wt. % inorganic diffusion particles with a size ranging between 1 and 7.5 μm.

The present invention relates to moldings for illuminated advertising and to processes for production of these moldings.

Many types of illuminated advertising are used. The moldings used often comprise plastics which have scattering agents so that the actual means of illumination are not discernible.

By way of example, the publication JP 11-172019 describes mixtures of Techpolymer SBX 4, Tospearl 2000, and inorganic scattering media, but there is a restriction on the size of the inorganic particles: up to 1 μm or greater than 8 μm. The moldings are produced via extrusion, and their surface gloss is not described.

The publication JP 2-194058 moreover discloses light-scattering plastics articles for illuminated advertising, where the article is composed of a PMMA matrix and of scattering particles. Silicone particles whose size is in the range from 1 to 6 μm can be mixed here with BaSO₄ particles whose size is from 1 to 7 μm. The proportion of plastics particles is greater than that of the inorganic particles, which are described as optional component. The minimum proportion of plastics particles in the moldings is merely described in terms of weight per unit surface area, and this variable is therefore dependent on the thickness of the articles, which is not, however, described. In the examples, the proportion of the plastics particles is at least 0.75% by weight. The moldings are produced via extrusion, but their surface gloss is not described.

The moldings described above certainly have a good property profile. However, many applications demand particularly smooth, high-specification surfaces. A factor which has to be considered here is that the plastics articles are produced in sheet form and are supplied to craftsmen who use these sheets to manufacture illuminated advertising units at the final user's premises. During this process, the plastic is heated. A disadvantage of the moldings described above is then that the heating process matts a smooth surface. Accordingly, these moldings cannot be used to produce particularly high-specification illuminated advertising units with a glossy surface.

However, articles produced via casting processes are likewise known for these high-specification illuminated advertising units. These processes involve dissolving polystyrene in methyl methacrylate and then curing this mixture in a casting mold. However, a disadvantage of these screening sheets is their relatively low weathering resistance together with their high yellowness index. This yellowness index increases in particular on prolonged heating, which can be necessary for further processing, or which can occur if conversion procedures are inappropriate.

In the light of the prior art discussed and stated herein, it was therefore an object of the present invention to provide high-specification moldings for illuminated advertising which can be formed at high temperatures without matting the surface of the moldings.

Another object of the invention was that the moldings have high durability, in particular high resistance to UV irradiation or to weathering.

The moldings should moreover have maximum mechanical stability.

A further object of the invention was to provide moldings which are particularly easy to produce. For example, the moldings should in particular be capable of production via casting processes which are carried out entirely automatically.

Another object of the present invention consisted in providing moldings whose size and shape can easily be adapted to the requirements.

Another object on which the present invention was based was to provide moldings for illuminated advertising which have a low yellowness index. This yellowness index should remain low even on prolonged heating to temperatures needed for the forming process.

These objects, and also other objects which although not expressly mentioned are self-evident from the circumstances discussed herein or inevitably result from these circumstances, are achieved via the moldings described in claim 1.

Advantageous embodiments of the inventive moldings are protected by the subclaims dependent on claim 1.

Claim 20 achieves the underlying object in relation to processes for production of moldings.

Moldings for illuminated advertising can be provided if moldings which encompass a poly(meth)acrylate matrix encompass from 0.05 to 0.5% by weight of plastic-containing scattering particles whose size is in the range from 5 to 15 μm and from 0.1 to 3% by weight of inorganic scattering particles whose size is in the range from 1 to 7.5 μm, and these moldings not only can be formed at high temperatures without matting the surface but also exhibit very resistance.

Among the advantages achieved via the inventive measures are the following:
The moldings of the present invention can be adapted to individual requirements without any resultant impairment of the attractiveness of the surface.
The moldings of the present invention can moreover be produced with particular ease. For example, the moldings can in particular be produced via casting processes which are carried out entirely automatically.
The inventive moldings exhibit high resistance to weathering, in particular to UV irradiation.
The inventive moldings have a particularly low yellowness index, which remains relatively low even on prolonged heating.
The size and shape of the moldings can be adapted to the requirements.

The molding of the present invention has from 0.05 to 0.5% by weight, preferably from 0.05 to 0.4% by weight, and particularly preferably from 0.1 to 0.3% by weight, of plastic-containing scattering particles, based on the weight of the molding. The size of these plastics particles is in the range from 5 to 15 μm, preferably from 6 to 12 μm, and particularly preferably from 7 to 11 μm.

The plastic-containing scattering particles which can be used according to the invention are known per se, and the nature of the plastic from which these scattering particles are produced is substantially non-critical.

Refraction of light takes place at the phase boundary between the plastic-containing scattering particles and the matrix plastic. Accordingly, the plastics particles have a refractive index n_{O}, measured at the Na D line (589 nm) and at 20° C., which differs by from 0.003 to 0.2 units, in particular from 0.02 to 0.2 units, when compared with the refractive index no of the matrix plastic.

The plastic-containing scattering particles preferably comprise crosslinked polystyrene, polysilicone, and/or crosslinked poly(meth)acrylates, these particles preferably being spherical.

Other particularly preferred plastics particles which are used as scattering agents comprise silicones. By way of example, these particles are obtained via hydrolysis and polycondensation of organotrialkoxy-silanes and/or of tetraalkoxysilanes, these being described by the formulae
R¹Si(OR²)₃ and Si(OR²)₄
where R¹ is, for example, a substituted or unsubstituted alkyl group, an alkenyl group, or a phenyl group, and the radical R² of the hydrolyzable alkoxy group is an alkyl group, such as methyl, ethyl, or butyl, or an alkoxy-substituted hydrocarbon group, such as 2-methoxyethyl or 2-ethoxyethyl. Examples of organotrialkoxysilanes are methyltrimethoxysilane, methyltriethoxysilane, methyl-n-propoxysilane, methyl-triisopropoxysilane, and methyltris(2-methoxyethoxy)-silane.

The abovementioned silane compounds and processes for production of spherical silicone particles from these are known to persons skilled in the art and can be found in the specifications EP 1 116 741, JP 63-077940, and JP 2000-186148.

Scattering agents used with particular preference in the present invention and composed of silicone are obtainable from GE Bayer Silicones with the trade names TOSPEARL® 120 and TOSPEARL® 3120.

Preferred plastic-containing scattering particles are composed of:
b1) from 25 to 99.9 parts by weight of monomers which have aromatic groups as substituents, e.g. styrene, α-methylstyrene, ring-substituted styrenes, phenyl(meth)acrylate, benzyl(meth)acrylate, 2-phenylethyl(meth)acrylate, 3-phenylpropyl(meth)acrylate, or vinyl benzoate; and
b2) from 0 to 60 parts by weight of an acrylic and/or methacrylic ester having from 1 to 12 carbon atoms in the aliphatic ester radical, these being copolymerizable with the monomers b1), examples which may be mentioned here being: methyl(meth)acrylate, ethyl(meth)acrylate, n-propyl(meth)acrylate, isopropyl(meth)acrylate, n-butyl(meth)acrylate, isobutyl(meth)acrylate, tert-butyl(meth)acrylate, cyclohexyl(meth)acrylate, 3,3,5-trimethylcyclohexyl(meth)acrylate, 2-norbornyl(meth)acrylate, or isobornyl(meth)acrylate;
b3) from 0.1 to 15 parts by weight of crosslinking comonomers which have at least two ethylenically unsaturated groups copolymerizable by a free radical route with b1) and, if appropriate, with b2), e.g. divinylbenzene, glycol di(meth)acrylate, 1,4-butanediol di(meth)acrylate, allyl(meth)acrylate, triallyl cyanurate, diallyl phthalate, diallyl succinate, pentaerythritol tetra(meth)acrylate, or trimethylolpropane tri(meth)acrylate, where the total amounts of the comonomers b1), b2), and b3) give 100 parts by weight.

Mixtures from which the plastic-containing scattering particles are produced particularly preferably comprise at least 80% by weight of styrene and at least 0.5% by weight of divinylbenzene.

The production of crosslinked plastic-containing scattering particles is known to persons skilled in the art. For example, the scattering particles may be produced by emulsion polymerization, for example as described in EP-A 342 283 or EP-A 269 324, and very particularly preferably via organic-phase polymerization, for example as described in the German Patent Application P 43 27 464.1. The last-mentioned polymerization technique gives particularly narrow particle size distributions or, in other words, particularly small deviations of particle diameters from the average particle diameter.

It is particularly preferable to use plastic-containing scattering particles which are heat-resistant to at least 200° C., in particular at least 250° C., but no resultant restriction is intended. The term “heat-resistant” here means that the particles are not subject to any substantial degradation caused by heat. Degradation caused by heat leads to undesirable discoloration, making the plastics material unusable.

Particularly preferred particles are obtainable, inter alia, from Sekisui with the trademarks Techpolymer® SBX-6, Techpolymer® SBX-8 and Techpolymer® SBX-12.

The molding of the present invention has from 0.1 to 3% by weight, preferably from 0.2 to 2.5% by weight, and particularly preferably from 0.3 to 2% by weight, of inorganic scattering particles, based on the weight of the molding. The size of these inorganic scattering particles is in the range from 1 to 7.5 μm, preferably from 2 to 5 μm, and particularly preferably from 3 to 4 μm, and preferred inorganic scattering particles here are spherical.

The inorganic scattering particles likewise have a refractive index at the Na D line (589 nm) and a refractive index n_{O} measured at 20° C. which differs, by from 0.003 to 0.2 units, in particular from 0.02 to 0.2 units, when compared with the refractive index n_{O} of the matrix plastic.

Inorganic scattering particles are likewise known per se and can be obtained commercially. These particles in particular encompass aluminum hydroxide, aluminum potassium silicate (mica), aluminum silicate (kaolin), barium sulfate (BaSO₄), calcium carbonate, magnesium silicate (talc).

In one particular aspect of the present invention, the proportion of inorganic scattering particles in the molding is greater than or equal to the proportion of plastic-containing scattering particles. The ratio by weight of the plastic-containing scattering particles to the inorganic scattering particles is preferably in the range from 1:1 to 1:20, in particular from 1:1.5 to 1:15, and particularly preferably from 1:2 to 1:10.

Laser extinction methods can be used to determine the particle size and the particle size distribution. Use may be made here of a Galay-CIS from L.O.T. GmbH, and the user manual here gives the test method for determining particle size and for determining particle size distribution. The person skilled in the art is aware of the size distribution of particles, and the particle sizes described above are based on the weight average.

It is preferable to use scattering particles with a narrow size distribution. In one particular aspect of the present invention, the light-scattering particles are spherical. The term “spherical” means for the purposes of the present invention that the particles preferably have a spherical shape, but it is obvious to the person skilled in the art that the methods of preparation may also give particles with another shape, or that the shape of the particles can deviate from the ideal spherical shape.

The term “spherical” accordingly means that the ratio of the largest dimension of the particles to the smallest dimension is at most 4, preferably at most 2, each of these dimensions being measured through the center of gravity of the particles. The proportion of spherical particles, based on the number of particles, is preferably at least 70%, particularly preferably at least 90%.

In one particular aspect of the present invention, these scattering particles have uniform distribution in the plastics matrix, with no significant aggregation or accumulation of the particles. “Uniformly distributed” means that the concentration of particles within the plastics matrix is substantially constant.

The molding encompasses, alongside the scattering particles, a plastics matrix which comprises polymethyl methacrylate (PMMA). Based on its weight, the molding preferably encompasses at least 30% by weight, in particular at least 70% by weight, and particularly preferably at least 90% by weight, of polymethyl methacrylate.

Polymethyl methacrylates are generally obtained via free-radical polymerization of mixtures which comprise methyl methacrylate. Based on the weight of the monomers, these mixtures generally comprise at least 40% by weight, preferably at least 60% by weight, and particularly preferably at least 80% by weight, of methyl methacrylate.

These mixtures for preparation of polymethyl methacrylates may also comprise other (meth)acrylates which are copolymerizable with methyl methacrylate. The expression “(meth)acrylates” encompasses methacrylates and acrylates, and also mixtures of the two.

These monomers are well-known. They include (meth)acrylates derived from saturated alcohols, for example methyl acrylate, ethyl(meth)acrylate, propyl(meth)acrylate, n-butyl(meth)acrylate, tert-butyl(meth)acrylate, pentyl(meth)acrylate and 2-ethylhexyl(meth)acrylate;

(meth)acrylates derived from unsaturated alcohols, for example oleyl(meth)acrylate, 2-propynyl(meth)-acrylate, allyl(meth)acrylate, vinyl(meth)acrylate;

aryl(meth)acrylates, such as benzyl(meth)acrylate or phenyl(meth)acrylate, where in each case the aryl radicals may be unsubstituted or have up to four substituents;

cycloalkyl(meth)acrylates, such as 3-vinylcyclohexyl(meth)acrylate, bornyl(meth)acrylate;

hydroxyalkyl(meth)acrylates, such as 3-hydroxypropyl(meth)acrylate, 3,4-dihydroxybutyl(meth)acrylate, 2-hydroxyethyl(meth)acrylate, 2-hydroxypropyl(meth)-acrylate;

glycol di(meth)acrylates, such as 1,4-butanediol(meth)acrylate, (meth)acrylates of ether alcohols, for example tetra-hydrofurfuryl(meth)acrylate, vinyloxyethoxyethyl(meth)acrylate;

amides and nitriles of (meth)acrylic acid, for example N-(3-dimethylaminopropyl)(meth)acrylamide, N-(diethylphosphono)(meth)acrylamide, 1-methacryloylamido-2-methyl-2-propanol;

sulfur-containing methacrylates, such as ethylsulfinyl-ethyl(meth)acrylate, 4-thiocyanatobutyl(meth)acrylate, ethylsulfonylethyl(meth)acrylate, thiocyanatomethyl(meth)acrylate, methylsulfinylmethyl(meth)acrylate, bis((meth)acryloyloxyethyl)sulfide;

polyfunctional(meth)acrylates, such as trimethyloyl-propane tri(meth)acrylate.

Besides the abovementioned (meth)acrylates, the mixes to be polymerized may also comprise other unsaturated monomers copolymerizable with methyl methacrylate and with the abovementioned (meth)acrylates.

They include 1-alkenes, such as 1-hexene, 1-heptene; branched alkenes, such as vinylcyclohexane, 3,3-di-methyl-1-propene, 3-methyl-l-diisobutylene, 4-methyl-1-pentene;

acrylonitrile;

vinyl esters, such as vinyl acetate;

styrene, substituted styrenes having an alkyl substituent in the side chain, e.g. α-methylstyrene and α-ethylstyrene, substituted styrenes having an alkyl substituent on the ring, such as vinyltoluene and p-methylstyrene, halogenated styrenes, such as mono-chlorostyrenes, dichlorostyrenes, tribromostyrenes and tetrabromostyrenes;

heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinyl-pyrimidine, vinylpiperidine, 9-vinylcarbazole, 3-vinyl-carbazole, 4-vinylcarbazole, 1-vinylimidazole, 2-methyl-1-vinylimidazole, N-vinylpyrrolidone, 2-vinyl-pyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinyl-thiazoles and hydrogenated vinylthiazoles, vinyl-oxazoles and hydrogenated vinyloxazoles;

vinyl and isoprenyl ethers;

maleic acid derivatives, such as maleic anhydride, methylmaleic anhydride, maleimide, methylmaleimide; and dienes, such as divinylbenzene.

The amount generally used of these comonomers is from 0 to 60% by weight, preferably from 0 to 40% by weight, and particularly preferably from 0 to 20% by weight, based on the weight of the monomers, and these compounds may be used individually or in the form of a mixture.

The polymerization is generally initiated using known free-radical initiators. Among the preferred initiators are, inter alia, the azo initiators well-known to persons skilled in the art, for example AIBN and 1,1-azobiscyclohexanecarbonitrile, and also peroxy compounds, such as methyl ethyl ketone peroxide, acetylacetone peroxide, dilauroyl peroxide, tert-butyl 2-ethylperhexanoate, ketone peroxide, methyl isobutyl ketone peroxide, cyclohexanone peroxide, dibenzoyl peroxide, tert-butyl peroxybenzoate, tert-butylperoxy isopropyl carbonate, 2,5-bis(2-ethylhexanoylperoxy)-2,5-dimethylhexane, tert-butyl 2-ethylperoxyhexanoate, tert-butyl 3,5,5-trimethylperoxyhexanoate, dicumyl peroxide, 1,1-bis(tert-butylperoxy)cyclohexane, 1,1-bis(tert-butylperoxy)-3,3,5-trimethylcyclohexane, cumyl hydroperoxide, tert-butyl hydroperoxide, bis(4-tert-butylcyclohexyl)peroxydicarbonate, mixtures of two or more of the abovementioned compounds with one another, and also mixtures of the abovementioned compounds with compounds not mentioned but likewise capable of forming free radicals.

The amount often used of these compounds is from 0.001 to 1.0% by weight, preferably from 0.05 to 0.3% by weight, based on the weight of the monomers.

The weight-average molar mass M_{W} of the homo- and/or copolymers to be used according to the invention as matrix polymers can vary within a wide range, and the molar mass here is usually matched to the intended application and to the mode of processing of the matrix. However, it is generally in the range from 20 000 to 10 000 000 g/mol, preferably from 50 000 to 3 000 000 g/mol, and particularly preferably from 80 000 to 1 500 000 g/mol, without any intended resultant restriction.

In one particular embodiment of the present invention, based on the weight of the molding, the matrix of the molding comprises at least 70% by weight, preferably at least 80% by weight, and particularly preferably at least 90% by weight, of polymethyl methacrylate.

In a particular aspect of the present invention, the poly(meth)acrylates of the matrix of the moldings have a refractive index of from 1.46 to 1.54, measured at the Na D line (589 nm) and at 20° C.

The molding compositions for producing the moldings may comprise conventional additives of any type. Among these are antistatic agents, antioxidants, mold-release agents, flame retardants, lubricants, dyes, flow improvers, fillers, light stabilizers, UV absorbers, and organophosphorus compounds, such as phosphites or phosphonates, pigments, agents providing weathering resistance and plasticizers. However, the amount of additives is limited in relation to the intended use. For example, neither the light-scattering properties of the moldings nor their transparency should be excessively impaired by additives.

In one particular aspect of the present invention, the molding composition may be given improved mechanical resistance properties via an impact modifier. These impact modifiers for polymethacrylate plastics are well-known, and examples of descriptions of the preparation and constitution of impact-modified polymethacrylate molding compositions are found in EP-A 0 113 924, EP-A 0 522 351, EP-A 0 465 049 and EP-A 0 683 028, inter alia.

Preferred impact-resistant molding compositions which can be used to produce the matrix have from 70 to 99% by weight of polymethyl methacrylates. These polymethyl methacrylates have been described above.

In one particular aspect of the present invention, the polymethyl methacrylates used to prepare impact-modified molding compositions are obtained via free-radical polymerization of mixtures which encompass from 80 to 100% by weight, preferably from 90 to 98% by weight, of methyl methacrylate and, where appropriate, from 0 to 20% by weight, preferably from 2 to 10% by weight, of other comonomers capable of free-radical polymerization, these likewise having been listed above. Particularly preferred comonomers are, inter alia, C₁-C₄-alkyl(meth)acrylates, in particular methyl acrylate, ethyl acrylate or butyl methacrylate.

The average molar mass M_{w} of the polymethyl methacrylates which can be used to produce the impact-modified matrix is preferably in the range from 90 000 to 200 000 g/mol, in particular from 100 000 to 150 000 g/mol.

Preferred impact-resistant molding compositions which can be used to produce the matrix comprise from 1 to 30% by weight, preferably from 2 to 20% by weight, particularly preferably from 3 to 15% by weight, in particular from 5 to 12% by weight, of an impact modifier, this being an elastomer phase composed of crosslinked polymer particles.

The impact modifier may be attained in a manner known per se via bead polymerization or via emulsion polymerization.

Preferred impact modifiers are crosslinked particles whose average particle size is in the range from 50 to 1000 nm, preferably from 60 to 500 nm and particularly preferably from 80 to 120 nm.

By way of example, these particles may be obtained via free-radical polymerization of mixtures which generally comprise at least 40% by weight, preferably from 50 to 70% by weight, of methyl methacrylate, from 20 to 80% by weight, preferably from 25 to 35% by weight, of butyl acrylate, and also from 0.1 to 2% by weight, preferably from 0.5 to 1% by weight, of a crosslinking monomer, e.g. a polyfunctional (meth)acrylate, e.g. allyl methacrylate, and which comprise comonomers which can be copolymerized with the abovementioned vinyl compounds.

Among the preferred comonomers are, inter alia, C₁-C₄-alkyl(meth)acrylates, such as ethyl acrylate or butyl methacrylate, preferably methyl acrylate, or other monomers including vinyl groups capable of polymerization, e.g. styrene. The mixtures for producing the abovementioned particles may preferably encompass from 0 to 10% by weight, with preference from 0.5 to 5% by weight, of comonomers.

Particularly preferred impact modifiers are polymer particles which have a two-layer, or particularly preferably a three-layer, core-shell structure. These core-shell polymers are described in EP-A 0 113 924, EP-A 0 522 351, EP-A 0 465 049 and EP-A 0 683 028, inter alia.

Particularly preferred impact modifiers based on acrylate rubber have the following structure, inter alia:
Core: Polymer with at least 90% by weight methyl methacrylate content, based on the weight of the core.
Shell 1: Polymer with at least 80% by weight butyl acrylate content, based on the weight of the first shell.
Shell 2: Polymer with at least 90% by weight methyl methacrylate content, based on the weight of the second shell.

The core may comprise not only the monomers mentioned but also other monomers, as may each of the shells. These other monomers have been described above, and particularly preferred comonomers have crosslinking action.

By way of example, a preferred acrylate rubber modifier may have the following structure:
Core: copolymer composed of methyl methacrylate (95.7% by weight) ethyl acrylate (4% by weight) and allyl methacrylate (0.3% by weight)
S1: copolymer composed of butyl acrylate (81.2% by weight), styrene (17.5% by weight) and allyl methacrylate (1.3% by weight)
S2: copolymer composed of methyl methacrylate (96% by weight) and ethyl acrylate (4% by weight).

The core:shell(s) ratio of the acrylate rubber modifiers may vary within a wide range. The core:shell ratio C/S is preferably in the range from 20:80 to 80:20, with preference from 30:70 to 70:30 in the case of modifiers with one shell, or in the case of modifiers with two shells the core:shell 1:shell 2 ratio C/S1/S2 is preferably in the range from 10:80:10 to 40:20:40, particularly preferably from 20:60:20 to 30:40:30.

The particle size of the core-shell modifier is usually in the range from 50 to 1000 nm, preferably from 100 to 500 nm and particularly preferably from 150 to 450 nm, without any intended resultant restriction.

Impact modifiers of this type are commercially obtainable from Mitsubishi with the trademark METABLEN® IR 441. It is also possible to obtain impact-modified molding compositions.

Particularly preferred molding compositions for production of the plastics matrix are obtainable commercially from Röhm GmbH & Co. KG.

The molding can be produced by way of known processes, preference being given to thermoplastic shaping processes. After addition of the particles, the molding compositions described above can be used to produce moldings via customary thermoplastic shaping processes.

The moldings can also be produced via casting processes. In these, by way of example, suitable (meth)acrylic mixtures are charged to a mold and polymerized. These (meth)acrylic mixtures generally comprise the (meth)acrylates described above, in particular methyl methacrylate. The (meth)acrylic mixtures may moreover comprise the copolymers described above, and also, in particular for viscosity adjustment, polymers, in particular poly(meth)-acrylates.

Surprisingly, the present invention permits viscosity adjustment to a prescribed value. The casting process for production of moldings for illuminated advertising can thus be automated. A factor which has to be considered here is that when uncrosslinked polystyrene is used as scattering medium, as is known from the prior art, it is necessary to use methyl methacrylate which has low, prescribed viscosity. If polymerized methyl methacrylate is added (syrup), the polystyrene precipitates, making it impossible to achieve homogeneous distribution of the polystyrene. The present invention solves this problem via a combination of inorganic scattering particles and plastic-containing scattering particles in a surprising manner.

By way of example, a suitable acrylic resin encompasses
A) from 0.05-0.5% by weight of plastic-containing scattering particles whose average diameter is in the range from 5 to 15 μm,
B) from 0.1-3% by weight of inorganic scattering particles whose average diameter is in the range from 1 to 7.5 μm,
C) from 40 to 99.85% by weight of methyl methacrylate,
D) from 0 to 59.85% by weight of comonomers,
E) from 0 to 59.85% by weight of polymers soluble in (C) or in (D), where components A) to E) give 100% by weight.

The acrylic resin moreover comprises the initiators needed for the polymerization process. Components A to D, and also the initiators, correspond to the compounds which are also used for preparation of suitable polymethyl methacrylate molding compositions. The acrylic resins may moreover encompass known additives, which have been described above by way of example. It is also possible to use additives which inhibit settling of the scattering particles.

For hardening, use may be made of what is known as the cell casting process, for example (see, by way of example, DE 25 44 245, EP-B 570 782, or EP-A 656 548) which polymerizes a plastics sheet between two glass plates sealed by a peripheral bead.

The weight-average molar mass M_{W} of the polymers prepared via cell casting processes is generally higher than the molar mass of polymers used in molding compositions. This gives a number of known advantages. The weight-average molar mass of polymers prepared via cell casting processes is generally in the range from 500 000 to 10 000 000 g/mol, without any intended resultant restriction.

The thickness of the molding is generally in the range from 0.05 to 200 mm, preferably in the range from 0.1 to 30 mm, without any intended resultant restriction.

In one particular embodiment of the present invention, the average surface roughness Ra of a portion of the sheet is at most 0.3 μm, in particular at most 0.2 μm, and particularly preferably at most 0.1 μm. It is preferable that at least 40%, in particular at least 48%, of the surface exhibits these values.

The average surface roughness Ra may be determined to DIN 4768 by using a Taylor Hobson Talysurf 50 tester.

The surface roughness Ra of the sheet is generally the result of variation of various parameters dependent on the nature of the production process.

In the case of production via extrusion, relevant parameters, inter alia, are the temperature of the melt during the extrusion process, a lower melt temperature giving a smoother surface. However, a factor which has to be considered here is that the temperature of the melt depends on the precise constitution of the molding composition. The temperature of the melt is generally in the range from 150 to 300° C., preferably in the range from 200 to 290° C. These temperatures are based on the temperatures of the melt on exit from the die.

Surface roughness can moreover be influenced by way of the gap between the rolls used for polishing of the sheets. If, by way of example, a polishing stack encompasses 3 rolls in an L arrangement, where the molding composition is conducted from the die into the gap between roll 1 and roll 2 and wraps around roll 2 to the extent of from 60 to 180°, polishing of the surfaces is achieved via the gap between roll 2 and roll 3. If the gap between roll 2 and roll 3 is adjusted to sheet thickness, the scattering particles on the sheet surface are impressed into the matrix, giving a smoother surface.

If the molding is produced via casting processes, the surface roughness results from the properties of the sheets used to produce the casting mold.

In one particular aspect of the present invention, the transmittance tau D65/10° of the molding to DIN 5036, especially if it has not been colored, is greater than or equal to 30%, in particular greater than or equal to 60%, and particularly preferably greater than or equal to 70%. Colored moldings generally have correspondingly lower transmittance values.

In one particular aspect of the present invention, the molding may be colored. Particularly suitable coloring materials are carbon black and/or dyes known per se.

Among these are copper phthalocyanine green, copper phthalocyanine blue, iron oxide red, ultramarine blue, chrome titanium yellow, and dyes of the anthraquinone series.

Particularly preferred dyes are commercially available. Among these are ®Sandoplast Red G and ®Sandoplast Yellow 2G, each available from Clariant, and also ®Macrolex Green 5B and ®Macrolex Violet 3R, each available from Bayer.

The molding may moreover comprise known soluble fluorescent dyes, e.g. those based on the chemical class of the perylenes. The fluorescent dyes may be mixtures composed of N,N′-disubstituted 3,4:9,10-perylenebis(dicarboximide) and of yellow-fluorescent dyes with defined color coordinate ranges under the CIE 1931 standard calorimetric system and fluorescence/luminescence factors greater than 5.

Fluorescent dyes of this type which are soluble in plastics, e.g. polycarbonate, polymethyl methacrylate, polyvinylidene fluoride, or mixtures of polymethyl methacrylate and polyvinylidene fluoride, and are suitable for yellow-fluorescent articles or yellow-fluorescent moldings are described inter alia in WO 99/16847.

Combination of fluorescent dyes with other colorants can give the screen a relatively wide range of color. By way of example, combination of a yellow-fluorescent dye with a green pigment, e.g. copper phthalocyanine green, is useful for producing a brilliant fluorescent green color.

Particularly suitable materials for the purposes of the invention are the commercially available fluorescent dyes Lumogen® F Orange 240, Lumogen® F Yellow 083, Lumogen® F Red 300 (Lumogen®: trademark of BASF AG, Ludwigshafen, Germany), and also Hostasol® Yellow 3G.

The concentration of these dyes depends on the desired perceived color, and also on the thickness of the sheet. Without any intended resultant restriction, this concentration for each dye is generally in the range from 0 to 0.8% by weight, preferably from 0.000001 to 0.4% by weight, based on the total weight of the colored moldings. The total of the dye concentrations is preferably in the range from 0 to 1% by weight, preferably from 0.0001 to 0.8% by weight, and particularly preferably from 0.01 to 0.5, based on the total weight of the colored moldings.

The moldings of the present invention may moreover comprise pigments. Among these are in particular white pigments whose refractive index difference from the plastics matrix is from +0.4 to 1.5, preferably from +0.5 to 1.4, particularly preferably from 1.0 to 1.3, and whose concentration in the plastics matrix may be from 0.001 to 0.1% by weight, preferably from 0.005 to 0.01% by weight.

Examples of preferred white pigments are titanium dioxide (TiO₂), zinc oxide (ZnO), or zinc sulfide (ZnS).

The molding preferably has a yellowness index D65/10° smaller than or equal to 12 to DIN 6167, in particular smaller than or equal to 10, without any intended resultant restriction.

The moldings of the present invention give excellent thermoforming without any resultant major impairment of the gloss of the surface or of the yellowness index of the molding. The forming process is known to the person skilled in the art. In this process, the molding is heated and formed over a suitable template. The temperature at which the forming process takes place depends on the softening point of the substrate from which the plastics article has been produced. The other parameters, such as the forming speed and forming force, are likewise dependent on the plastic, and these parameters are known to the person skilled in the art. Among the forming processes, particular preference is given to bending processes. Processes of this type are used in particular for the processing of cast sheet. Further details are found in “Acrylglas und Polycarbonat richtig Be- und Verarbeiten” [Correct machining and processing of acrylic sheet and polycarbonate] by H. Kaufmann et al. edited by Technologie-Transfer-ring Handwerk NRW and in VDI-Richtlinie 2008 sheet 1 and DIN 8580/9/.

One particular embodiment of the molding of the present invention has a halved-intensity angle greater than or equal to 15°, in particular greater than or equal to 25°.

In one particular aspect of the present invention, the haze of the molding to DIN 5036 is greater than or equal to 0.15, in particular greater than or equal to 0.35, without any intended resultant restriction.

In one preferred embodiment, the surface of the inventive polymethyl methacrylate sheets exhibits a glossy reflection. This can be characterized via gloss measurement using a reflectometer to DIN 67530. The gloss of the sheets at an angle of 85° is preferably at least 50, particularly preferably at least 60, and very particularly preferably at least 70. These values are based on a portion of the surface of the molding, and it is preferable that at least 40%, in particular at least 48%, of the surface of the molding exhibits these values. A factor which has to be taken into account here is that 50% of the surface faces toward the inside, toward the means of illumination. That portion of the surface is therefore not visible from outside. Accordingly, the surface oriented toward the outside and facing away from the means of illumination should have maximum gloss.

The length of an inventive molding is preferably in the range from 25 mm to 10 000 mm, preferably from 50 to 3000 mm, and particularly preferably from 200 to 2000 mm. The width of this particular embodiment is generally in the range from 25 to 10 000 mm, preferably from 50 to 3000 mm, and particularly preferably from 200 to 2000 mm.

In one particular embodiment, the weathering resistance of the molding to DIN EN ISO 4892, part 2—Methods of exposure to laboratory light sources: xenon arc sources—is particularly high.

The inventive plastics articles generally have very high weathering resistance. For example, the weathering resistance to DIN 53387 (Xenotest) is at least 5000 hours.

In one preferred aspect, moldings may have an impact strength of at least 10 kJ/m² to ISO 179/1, preferably at least 15 kJ/m².

The molding preferably has a modulus of elasticity to ISO 527-2 of at least 1000 MPa, in particular at least 1500 MPa, without any intended resultant restriction.

The invention is explained in more detail below via inventive examples and comparative examples, but there is no intention that the invention be restricted to these examples.

### INVENTIVE EXAMPLE 1

An inventive molding was produced in a cell casting process. For this, 1 part by weight of 2,2′-azobis(2,4-dimethylvaleronitrile) and 2 parts by weight of Techpolymer SBX 8 were added to 1000 parts by weight of prepolymerized methyl methacrylate (viscosity about 1000 mPa*s). A paste which encompasses 3 parts by weight of a methyl-methacrylate-soluble polymethacrylate resin, 7.5 parts by weight of BaSO₄ particles whose size is about 3.5 μm, and 30 parts by weight of methyl methacrylate was dissolved in this mixture. The constituents of the paste were dispersed by a high-speed dispersant.

The mixture was stirred vigorously, charged to a silicate glass cell with a bead of thickness 3 mm as spacer, and polymerized in a water bath at 45° C. Final polymerization took place in a drying cabinet at 115° C. The optical properties of the molding were studied, the results being shown in table 1. The rear-illumination test is carried out in a light box with an incandescent lamp with transparent glass bulb (60 watt). The specimen here is held at a distance of from about 5 to 50 cm therefrom. If the element is not visible, the result is indicated by + in table 1. Otherwise, table 1 shows a − sign.

The molding was also heated to 160° C. for 10 minutes and shaped in vacuo to a depth of about 3-4 cm. The change in surface gloss is likewise shown in table 1. If the gloss of the surface is retained, the result is indicated by + in table 1. Otherwise, table 1 shows a − sign. Transmittance tau D65/10° was determined to DIN 5036. Yellowness index D65/10° was determined to DIN 6167.

The molding was then divided, and the various portions were subjected to various resistance tests, the results obtained being shown in table 2. For this, a specimen was heated to 180° C. for 30 minutes, and the yellowness index and transmittance were then determined. A Xenotest was also carried out for 5000 hours, and then the yellowness index and transmittance were determined.

### INCENTIVE EXAMPLE 2

Inventive example 1 is in essence repeated, but 2 parts by weight of BaSO₄ particles whose size is 3.5 μm are added. The results obtained by the methods described above are likewise listed in tables 1 and 2.

### COMPARATIVE EXAMPLE 1

Inventive example 1 is in essence repeated, but no plastic-containing scattering particles are used. The results obtained by the methods described above are likewise listed in tables 1 and 2.

### COMPARATIVE EXAMPLE 2

Inventive example 1 is in essence repeated, but no inorganic scattering particles are used. Instead, 13.3 parts by weight of SBX 8 are added to the mixture. The results obtained by the methods described above are likewise listed in tables 1 and 2.

### COMPARATIVE EXAMPLE 3

The fundamentals of inventive example 1 are repeated, but no prepolymer is used. Instead, 10 parts by weight of polystyrene are dissolved in 1000 parts by weight of methyl methacrylate. This mixture is then polymerized in a cell as in inventive example 1.

The results obtained by the methods described above are likewise listed in tables 1 and 2.

TABLE 1

| | | | Rear- | |
|---|---|---|---|---|
| | | Yellowness | illumination | Forming |
| | Transmittance | index | test | test |
| Inventive | 71 | 3 | + | + |
| example 1 | | | | |
| Inventive | 84 | <1 | + | + |
| example 2 | | | | |
| Comparative | 72 | 3 | − | + |
| example 1 | | | | |
| Comparative | 80 | 9 | + | − |
| example 2 | | | | |
| Comparative | 72 | 12 | + | + |
| example 3 | | | | |

TABLE 2

| | | | After 5000 hours of | |
|---|---|---|---|---|
| | After 30 minutes, 180° C. | | Xenotest | |
| | Trans- | Yellowness | Trans- | Yellowness |
| | mittance | index | mittance | index |
| Inventive | 71 | 3 | 71 | 3 |
| example 1 | | | | |
| Inventive | 84 | <1 | 84 | <1 |
| example 2 | | | | |
| Comparative | 72 | 3 | 72 | 3 |
| example 1 | | | | |
| Comparative | 78 | 10 | 72 | 10 |
| example 2 | | | | |
| Comparative | 66 | 21 | 70 | 9.5 |
| example 3 | | | | |

The inventive examples and comparative examples show that only the inventive mixtures give a very good property profile. If only inorganic particles are used it is impossible to achieve adequate scattering action, leading to failure in the rear-illumination test. If, in contrast, relatively large amounts of plastics particles are used, the surface of the moldings becomes matt after heating. Furthermore, the transmittance of these moldings falls sharply on irradiation with UV light. Customary moldings in which polystyrene is used as scattering medium exhibit a very marked increase in yellowness index and marked reduction of transmittance on heating. UV resistance is moreover also poorer than that of inventive moldings.

1. A molding for illuminated advertising comprising
a poly(meth)acrylate matrix, scattering particles comprising plastic, and inorganic scattering particles,
wherein said molding comprises from 0.05 to 0.5% by weight of the scattering particles comprising plastic whose size is in the range from 5 to 15 μm, and
from 0.1 to 3% by weight of inorganic scattering particles whose size is in the range from 1 to 7.5 μm.

2. The molding as claimed in claim 1, characterized in that at least a portion of its surface has a gloss R_{85°} greater than or equal to 50.

3. The molding as claimed in claim 2, characterized in that at least 40% of its surface has a gloss R_{85°} greater than or equal to 50.

4. The molding as claimed in claim 1, characterized in that at least a portion of its surface has an average surface roughness Rₐ of at most 0.3 μm.

5. The molding as claimed in claim 2, characterized in that at least 40% of its surface has an average surface roughness Rₐ of at most 0.3 μm.

6. The molding as claimed in claim 1, characterized in that the size of the inorganic scattering particles is in the range from 2 to 5 μm.

7. The molding as claimed in claim 1, characterized in that the inorganic scattering particles comprise BaSO₄.

8. The molding as claimed in claim 1, characterized in that the size of the scattering particles comprising plastic is in the range from 6 to 12 μm.

9. The molding as claimed in claim 1, characterized in that it has from 0.05 to 0.3% by weight of scattering particles comprising plastic.

10. The molding as claimed in claim 1, characterized in that the scattering particles comprising plastic comprise crosslinked polystyrene.

11. The molding as claimed in claim 1, characterized in that the proportion of inorganic scattering particles in the molding is greater than or equal to the proportion of scattering particles comprising plastic.

12. The molding as claimed in claim 1, characterized in that it has been colored.

13. The molding as claimed in claim 1, characterized in that its transmittance tau D65/10° to DIN 5036 is at least 30%.

14. The molding as claimed in claim 1, characterized in that its yellowness index D65/10° to DIN 6167 is smaller than or equal to 10.

15. The molding as claimed in claim 1, characterized in that its halved-intensity angle is greater than or equal to 15°.

16. The molding as claimed in claim 1, characterized in that its haze to DIN 5036 is greater than or equal to 0.15.

17. The molding as claimed in claim 1, characterized in that its impact resistance to ISO 179/1 is at least 10 kJ/m².

18. The molding as claimed in claim 1, characterized in that its modulus of elasticity to ISO 527-2 is at least 1500 MPa.

19. The molding as claimed in claim 1, characterized in that its weathering resistance to DIN 53 387 is at least 5000 hours.

20. A process for production of moldings as claimed in claim 1, comprising
polymerizing an acrylic resin in a casting mold, wherein the acrylic resin comprises methyl methacrylate, inorganic scattering particles, and scattering particles comprising plastic.

21. The process for production of moldings as claimed in claim 20, characterized in that the viscosity of the acrylic resin is in the range from 200 to 20 000 mPa*s.
